(19) United States
(12) Patent Application Publication
(10) Pub. No.: US 2007/0028727 A1
(43) Pub. Date: Feb. 8, 2007

(54) HANDLES FOR HAND TOOLS

(76) Inventor: Richard K. Schiller, Sunnyvale, TX (US)

Correspondence Address: MICHAEL A. O'NEIL, P.C., 5949 SHERRY LANE, SUITE 820, DALLAS, TX, 75225, US

(21) Appl. No.: 11/462,126

(22) Filed: Aug. 3, 2006

Related U.S. Application Data
(60) Provisional application No. 60/706,189, filed on Aug. 5, 2005.

(51) Int. Cl. B25B 23/16; B25G 1/00

(52) U.S. Cl. 81/177.3; 81/177.1

(57) ABSTRACT

A handle for use in conjunction with wrench heads comprises apertures for receiving a user's fingers enabling a user to use the wrench head without having to exert constant pressure on the handle and a shorter length than conventional wrench handles thereby enabling access hard to reach areas. The handle further comprises a more ergonomic grip as compared with conventional tool handles. Additional embodiments of the handle provide alternative shapes which enable a user to apply more force at the tool while applying less force to the handle.

### CROSS-REFERENCE TO RELATED APPLICATION

This application claims priority based on provisional patent application Ser. No. 60/706,189 filed Aug. 5, 2005, the entire content of which is incorporated herein by reference.

### TECHNICAL FIELD

This invention relates generally to handles for hand tools, and more particularly to hand tool handles that are ergonomic in design thereby facilitating hand tool usage.

### BACKGROUND AND SUMMARY OF THE INVENTION

Hand tools have been utilized by craftsmen of all trades for centuries. Wrenches in particular are used in a wide variety of mechanical and electrical trades. For example, the CRESCENT® wrench is one of the more frequently used tools in the plumbing industry. Likewise, several different wrench types are used in conjunction with automobile repairs. Heretofore, conventional wrench handles have typically been straight and have required the user to wrap his/her fingers around the handle. In addition to requiring ongoing pressure to maintain a grip on the handle the size and shape of conventional wrench handles has often limited access to fasteners requiring manipulation by the wrench.

The present invention comprises improvements in hand tool handles which overcome the foregoing and other difficulties which have long since characterized the prior art. In accordance with the broader aspects of the invention a hand tool handle provides apertures for receiving a user's fingers therethrough thereby enabling a user to control the tool without maintaining constant finger pressure around the handle. Further, handles incorporating the invention provide a more ergonomic approach to applying force to the tool and accessing tight spaces.

In accordance with more specific aspects of the invention a hand tool handle comprises one or more apertures sized for receiving a user's fingers therethrough. The handle may be secured to a tool such that the handle extends substantially parallel to the tool, or the handle may extend angularly relative to the tool. The handle may further comprise a padded material providing additional comfort during use. Alternatively, the handle may be provided with an insulating covering when used in conjunction with repair and maintenance of electrical apparatuses. The handle of the present invention may further comprise means for interchanging different tool types including but not limited to an adjustable CRESCENT® wrench head, a ratchet wrench head, an open head wrench, and a box wrench head. The length of the handle is substantially shorter relative to a conventional handle designs thereby facilitating access to fasteners in tight or hard to access spaces.

Rather than a straight body, the handle of the present invention may comprise alternative shapes and sizes. One embodiment of the present invention comprises a curved body, similar to an s-shape, which is more ergonomic as compared to a conventional straight handle thereby enabling a user to generate more force the tool without exerting more force on the handle. An alternative variation of the handle comprises a z-shaped body having a tool at each end thereof. Alternatively, the handle may comprise a body which extends from the tool at a 90 degree angle and further comprises another 90 degree angle forming the grip, similar to an L-shape, enabling a user to access hard to reach areas without extending the arms, for example a valve directly beneath a sink drain or mechanical components under the hood of a car.

### BRIEF DESCRIPTION OF THE DRAWINGS

A more complete understanding of the present invention may be had by reference to the following Detailed Description when taken in connection with the accompanying Drawings, wherein:

FIG. 1 is a perspective view illustrating a hand tool handle comprising a first embodiment of the present invention;

FIG. 2 is a first view of the handle shown in FIG. 1 wherein the handle extend angularly outwardly from the tool;

FIG. 3 is a view similar to FIG. 2 showing the handle of FIG. 1 extending angularly outwardly from the tool at an alternative angle;

FIG. 4 is a front view of the handle shown in FIG. 1 comprising cushioning on the handle;

FIG. 5 is a perspective view of the handle shown in FIG. 1 comprising means for interchanging the handle with different tools;

FIG. 6 is a front view illustrating a handle comprising a second embodiment of the present invention;

FIG. 7 is a front view illustrating a handle comprising a third embodiment of the present invention;

FIG. 8 is a front view illustrating a handle comprising a fourth embodiment of the present invention; and

FIG. 9 is a front view illustrating a handle comprising a fifth embodiment of the present invention.

### DETAILED DESCRIPTION

Various embodiments of the handle for hand tools comprising the present invention are illustrated in the Drawings. Referring particularly to FIGS. 1 through 5, there is shown a handle 10 comprising a first embodiment of the invention. The handle 10 comprises a body 12 affixed to a tool 14. The tool 14 comprises a wrench head, it being understood that the present invention is also applicable to other types of tools.

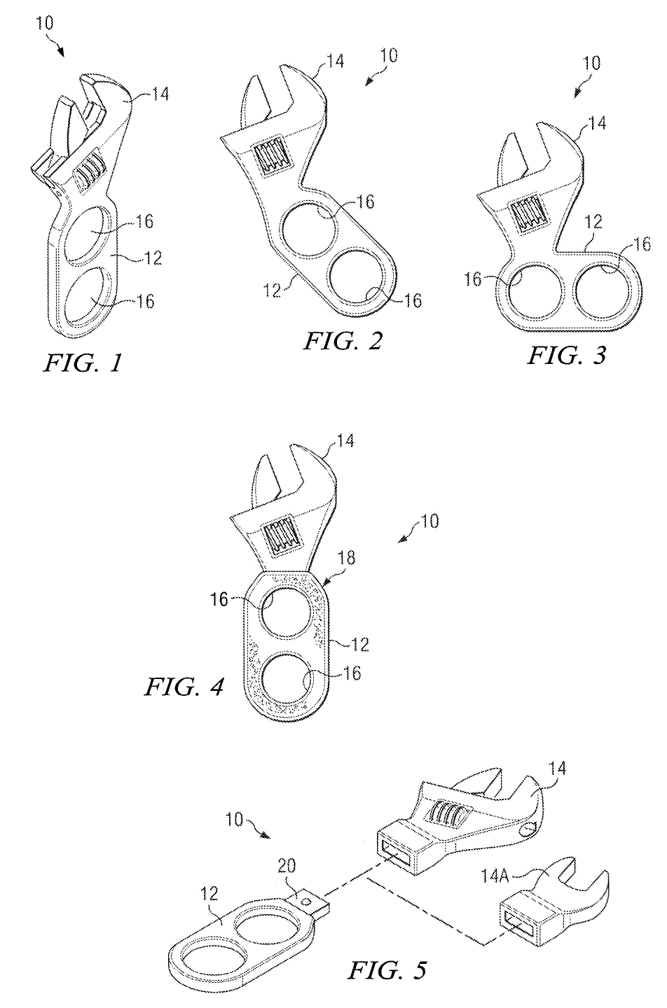

The body 12 comprises two or more apertures 16 for receiving at least two fingers. The body 12 and the tool 14 preferably comprise an integral structure. Alternatively, the body 12 may be secured to the tool 14 by welding or other attachment means known to those skilled in the art of hand tools. As shown in FIG. 1, the proximal end of the body 12 may be secured to the tool 14 such that the body 12 extends parallel to the tool 14. Alternatively, as shown in FIGS. 2 and 3, the proximal end of the body 12 may be secured to the tool 14 such that the body 12 extends angularly relative to the tool 14, e.g., at approximately a 45 degree angle as shown in FIG. 2 or at a 90 degree angle as shown in FIG. 3.

FIG. 4 illustrates the handle 10 further comprising padding 18 applied around the outer surface of the body 12. The padding 18 facilitates additional comfort during use and provides an ergonomic advantage as compared with conventional tool handles. Alternatively, the padding 18 may provide insulation for the handle 10 when used in conjunction with repair and maintenance of electrical apparatuses.

As shown in FIG. 5, the handle 10 may be used in conjunction with different tool types. The body 12 comprises a receiving member 20 for attachment of various tools 14, 14A, etc. thereto. Similarly, the tools 14, 14A, etc. have apertures formed therein which receive the receiving member 14 for mating engagement with the body 12.

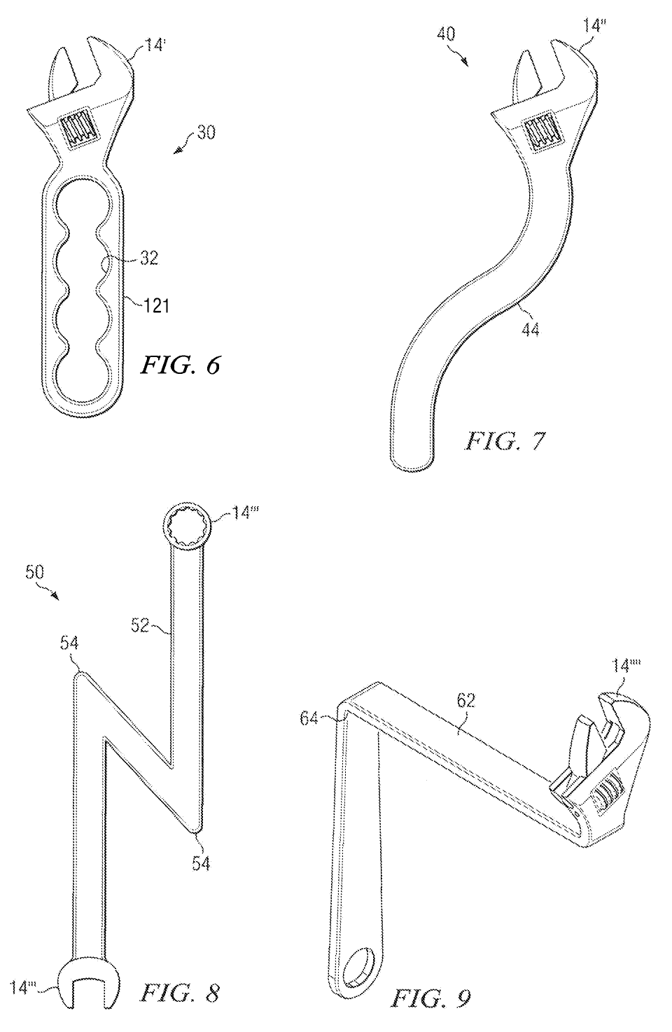

Referring to FIG. 6, there is shown a hand tool handle 30 comprising a second embodiment of the present invention. Many of the portions of the handle 30 are substantially identical in construction and function to the components of the handle 10 illustrated in FIGS. 1 through 5 and described hereinabove in conjunction therewith. Such identical component parts are designated in FIG. 6 with the same reference numerals utilized above in the description of the handle 10, but are differentiated therefrom by means of a prime (′) designation.

The handle 30 differs from the handle 10 of FIGS. 1 through 5 in that the handle 30 comprises a body 12′ comprising a single aperture 32 for receiving up to four fingers of a user. The proximal end of the body 12′ is secured to the tool 14′ such that the body 12′ extends parallel relative to the tool 14′. However, the angularly extending configurations shown in FIGS. 2 and 3 are equally applicable to the handle 30. The body 32 of the wrench handle 30 may be configured to incorporate recesses for the receiving fingers of a user similar to the apertures 16 shown in FIGS. 1 through 5 and likewise incorporate padding 18 as shown in FIG. 4.

FIG. 7 illustrates a handle 40 comprising yet another embodiment of the present invention. Many of the portions of the handle 40 are substantially identical in construction and function to the components of the handle 10 illustrated in FIGS. 1 through 5 and described hereinabove in conjunction therewith. Such identical component parts are designated in FIG. 7 with the same reference numerals utilized above in the description of the handle 10, but are differentiated therefrom by means of a double prime (″) designation.

The handle 40 differs from the handle 10 of FIGS. 1 through 5 in that the handle 40 comprises a substantially curved body 44 having an s-shape. The curved body 44 enables a user to produce more force by the tool 14″ while exerting less force to the body 44. The wrench handle 40 provides an ergonomic advantage as compared with conventional handles thereby requiring less force than is required for conventional handles in order to achieve the same result. The body 44 of the handle 40 may be configured to incorporate apertures for receiving fingers of a user similar to the apertures 16 shown in FIGS. 1 through 5 and likewise incorporate padding 18 as shown in FIG. 4.

Referring to FIG. 8, there is shown a handle 50 comprising another embodiment of the present invention. Many of the portions of the handle 50 are substantially identical in construction and function to the components of the handle 10 illustrated in FIGS. 1 through 5 and described hereinabove in conjunction therewith. Such identical component parts are designated in FIG. 8 with the same reference numerals utilized above in the description of the handle 10, but are differentiated therefrom by means of a triple prime (′″) designation.

The handle 50 differs from the handle 10 of FIGS. 1 through 5 in that the handle 50 comprises a body 52 having two bends 54 near the center thereof. Further, the handle 50 comprises two tools 14′″ secured to the body 52 on both ends thereof. The “z-shaped” body 52 enables a user to produce more force on the tools 14′″ while exerting less force to the body 52. The handle 50 provides an ergonomic advantage as compared with conventional handle designs thereby requiring less force on the body than is required for conventional handles in order to achieve the same results. The body 52 of the handle 50 may be configured to incorporate apertures for receiving fingers of a user similar to the apertures 16 shown in FIGS. 1 through 5 and likewise incorporate padding 18 as shown in FIG. 4.

Referring to FIG. 9, there is shown a handle 60 comprising yet another embodiment of the present invention. Many of the portions of the handle 60 are substantially identical in construction and function to the components of the handle 10 illustrated in FIGS. 1 through 5 and described hereinabove in conjunction therewith. Such identical component parts are designated in FIG. 9 with the same reference numerals utilized above in the description of the handle 10, but are differentiated therefrom by means of a quadruple prime (″″) designation.

The handle 60 differs from the handle 10 of FIGS. 1 through 5 in that the handle 60 comprises a body 60 having a right angle bend 64 near the center thereof. Additionally, the body 62 extends outwardly from the tool 14″″ at substantially a 90 degree angle. The relationship of the body 62 to the tool 14″″ enables a user to access hard to reach items without requiring extending an arm or placing a hand in a tight and possibly dangerous space. The body 62 of the handle 60 may be configured to incorporate apertures for receiving fingers of a user similar to the apertures 16 shown in FIGS. 1 through 5 and likewise incorporate padding 18 as shown in FIG. 4.

The present invention has been illustrated in conjunction with tools of various types including a CRESCENT® wrench, an open wrench, and a ratchet wrench, but the wrench handle may be configured to be used with other wrench types and equally applicable to other hand tools such as screw drivers and the like.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. For use in conjunction with a hand tool the type including a wrench head and a handle secured to and extending from the wrench head, the improvement comprising:
the handle having at least one aperture formed therethrough for receiving at least two fingers of a hand of a user of the tool.

2. The improvement according to claim 1 wherein the handle comprises a plurality of apertures each for receiving a single finger of a hand of a user of the tool.

3. The improvement according to claim 1 wherein the handle comprises a single aperture for receiving multiple fingers of a hand of a user of the tool.

4. The improvement according to claim 1 wherein the handle extends parallel to the wrench head.

5. The improvement according to claim 1 wherein the handle extends angularly relative to the wrench head.

6. The improvement according to claim 5 wherein the handle extends at an angle of about 45° relative to the wrench head.

7. The improvement according to claim 5 wherein the handle extends at an angle of about 90° relative to the wrench head.

8. The improvement according to claim 1 further including a padding layer extending over the exterior surfaces of the handle.

9. The improvement according to claim 8 wherein the padding layer comprises an electrically insulative material.

10. The improvement according to claim 1 wherein the handle is detachably secured to the wrench head thereby facilitating the use of the handle with a plurality of wrench heads.

11. For use in conjunction with a hand tool of the type including a wrench head and a handle secured and extending from the wrench head, the improvement comprising:
the handle having an s-shape whereby the distal end of the handle is laterally offset from the wrench head.

12. For use in conjunction with a hand tool of the type including two wrench heads and a handle secured to and extending between the two wrench heads, the improvement comprising:
the handle having a z-shape whereby the two wrench heads are laterally offset one from the other.

13. For use in conjunction with a hand tool of the type including a wrench head and a handle secured to and extending from the wrench head, the improvement comprising:
the handle having an L-shaped configuration whereby the wrench head extends in a first plane and the distal end of the handle extends in a second plane that is parallel to and substantially offset from the first plane.
